(19) United States
(12) Patent Application Publication
(10) Pub. No.: US 2024/0143776 A1
(43) Pub. Date: May 2, 2024

(54) VULNERABILITY MANAGEMENT FOR DISTRIBUTED SOFTWARE SYSTEMS

(71) Applicant: VMWARE, INC., Palo Alto, CA (US)

(72) Inventors: Padmini Sampige Thirumalachar, Bangalore (IN); Madhan Sankar, Bangalore (IN); Punith S, Bangalore (IN); Smeeth Virpariya, Bangalore (IN)

(21) Appl. No.: 17/975,651

(22) Filed: Oct. 28, 2022

(51) Int. Cl. G06F 21/57

(52) U.S. Cl. CPC G06F 21/577; G06F 2221/033; G06F 2221/034

(57) ABSTRACT

In an example, a computer-implemented method may include receiving vulnerability data indicative of a vulnerability associated with a computing environment from a security scanning platform. Further, the method may include determining a type of the vulnerability and determining an operating system component, an application component, or both being vulnerable to a security threat based on the type of vulnerability. Furthermore, the method may include determining a compute node, of the computing environment, hosting the operating system component, the application component, or both that are vulnerable. Further, the method may include generating an alert notification indicating that the operating system component, the application component, or both along with the determined compute node are vulnerable to the security threat.

### TECHNICAL FIELD

The present disclosure relates to security vulnerabilities in computing environments, and more particularly to methods, techniques, and systems to manage vulnerabilities for distributed software systems and associated components in the computing environments.

### BACKGROUND

In recent years, security vulnerabilities in products and/or services have been attacked by ever-changing security attacks (e.g., malware, ransomware, and the like) that present constant, new threats to the security of computing devices. Such security attacks have caused data corruption, allowed access to and/or the conversion of otherwise prohibited content, information, privileges, and the like, caused disclosure of private information, caused monetary loss, caused reputational damage, and the like. Often, the security vulnerabilities affect both product/service providers and consumers of vulnerable products and/or services. Service providers and consumers are frequently concerned whether they are susceptible to security vulnerabilities of their products and/or services. Accordingly, constant effort is made to keep pace with the ever-increasing number and variety of security attacks.

### BRIEF DESCRIPTION OF THE DRAWINGS

FIG. 1 is a block diagram of an example computing environment, depicting a management node to detect and flag vulnerabilities for a distributed software system;

FIG. 2 is a flow diagram illustrating an example computer-implemented method for generating an alert notification indicating a vulnerability in a computing environment;

FIG. 3A is a flow diagram illustrating another example computer-implemented method for generating an alert notification indicating a vulnerability in a business application;

FIG. 3B is a flow diagram illustrating yet another example computer-implemented method for generating an alert notification based on a vulnerability in a business application;

FIG. 4A is an example graphical user interface depicting a distributed software system operating on multiple distributed compute nodes connected over the Internet;

FIG. 4B is an example graphical user interface depicting a summary of vulnerabilities in the distributed software system;

FIG. 4C is an example graphical user interface depicting generated alerts corresponding to individual application components of the distributed software system;

FIG. 4D is an example graphical user interface depicting generated alert details corresponding to an alert of FIG. 4C; and

FIG. 5 is a block diagram of an example management node including non-transitory computer-readable storage medium storing instructions to detect vulnerabilities in a computing environment.

The drawings described herein are for illustrative purposes and are not intended to limit the scope of the present subject matter in any way.

### DETAILED DESCRIPTION

Examples described herein may provide an enhanced computer-based and/or network-based method, technique, and system to manage vulnerabilities for a distributed software system (e.g., a business service) and associated infrastructure in a computing environment. The paragraphs [0014] to [0019] present an overview of the computing environment, existing methods to notify vulnerabilities in the computing environment, and drawbacks associated with the existing methods.

Computing environment may be a physical computing environment (e.g., an on-premises enterprise computing environment or a physical data center) and/or virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in a virtual space being hosted by one or more physical data centers. Example virtual computing environment may include different compute nodes (e.g., physical computers, virtual machines, and/or containers). Further, the computing environment may include multiple application hosts (i.e., physical computers) executing different workloads such as virtual machines, containers, and the like running therein. Each compute node may execute different types of applications and/or operating systems.

Computing resources are physical/virtual computing devices and/or software applications; any or all of which may be offered as a product and/or a service. Example resources may include virtual machines (VMs), software appliances, management agents (e.g., a Common Information Management (CIM) agent, a Simple Network Management Protocol (SNMP) agent, and/or a configuration management agent), cloud services, mobile agents (e.g., mobile software application code and a corresponding application state), and/or business services (e.g., Information Technology Infrastructure library services).

Monitoring and management platforms, such as vRealize Operations (vROps) offered by Vmware, may assist administrators to monitor, troubleshoot, and manage the health and capacity of private, hybrid, and multi-cloud environments. Such monitoring and management platforms may support operations and management associated with the applications and operating systems. For example, vROps is uniquely positioned to provide insights into:
Health of business-critical applications, and
Health of Infrastructure.

Computing resources are susceptible to security vulnerabilities or attacks, such as denial of service, privilege elevation, directory traversal, buffer overflow, unauthorized remote or local execution/access, information leakage, and the like. Such attacks can be particularly damaging and costly for enterprises such as corporations, governments, and other organizations. A vulnerability may refer to a weakness or flaw in software, hardware, or firmware of a compute node. Such weakness might allow an adversary to violate the confidentiality, the availability, and the integrity of a computing system (e.g., a compute node), and its processes or applications. In network security, a vulnerability may refer to the weakness of a compute node that could allow unauthorized intrusion in a network of the computing environment. Security vulnerabilities are problematic as they may lead to unrestricted access to prohibited information.

Every year, the organisations lose a significant amount of money (e.g., millions of dollars) in security breaches. In this regard, software providers or vendors (e.g., VMware®, Microsoft®, and the like) may regularly issue public warning and advisories to their users about newly discovered vulnerabilities in their software products (e.g., vCenter, virtual storage area network (vSAN), Microsoft Windows, Microsoft Office software, and the like). However, despite the information, the users are either not aware or do not take the necessary actions to remediate the vulnerabilities.

With security becoming the most critical aspect of any business, any early detection, notification, and action on the threat/vulnerabilities may provide a value-add to the customers. Existing security scanning tools such as Appcheck (e.g., for detecting vulnerability in the code, operating system, third party software, and the like), Nessus (e.g., for scanning the information technology infrastructure, security audit, and the like), Carbon Black (e.g., for detecting vulnerabilities in the application), and the like facilitate in detecting the vulnerabilities in an application (e.g., the application may be a construct which involves infrastructure elements that act together to enable a service). In these examples, the online tools detect the vulnerabilities by scanning the complete code of the application or the libraries at compile time. The vulnerability scan may be a long running job, which is hosted in a separate environment.

Upon detecting the vulnerabilities, the vulnerabilities are raised as defects/tickets in JIRA, which is a cloud-based proprietary issue-management product that provides bug tracking functionality, for instance. Further, a user may have to figure out manually any critical vulnerability is exposing the application and infrastructure to danger of exploitation from hackers. In this case, the user may have to log in to a management tool and manually search for the exact (which/where) element(s) in the infrastructure that is affected by vulnerability. Upon identification, the risk may have to be mitigated manually or using some configuration tools like Chef, Salt, VMware Aria Automation Orchestrator (vRO), or the like. The manual action may lead to a significantly longer time for resolution and may be error prone. Thus, manual actions may lead to loss of time and data, which is critical in detection/notification/mitigation of the vulnerabilities.

Examples described herein may provide a management node to automatically flag vulnerabilities at application and infrastructure levels by generating notifications indicating the vulnerabilities in a computing environment. The application (e.g., a business application) is a construct which involves infrastructure parties that act together to enable a business service. The management node may receive vulnerability data indicative of a vulnerability associated with a computing environment from a security scanning platform (e.g., Appcheck, Nessus, Carbon Black, and the like). Further, the management node may determine a type of the vulnerability and determine an operating system component, an application component, or both being vulnerable to a security threat based on the type of vulnerability. Furthermore, the management node may determine a compute node, of the computing environment, hosting the operating system component, the application component, or both that are vulnerable. Further, the management node may generate an alert notification indicating that the operating system component, the application component, or both along with the determined compute node are vulnerable to the security threat. Thus, examples described herein may provide a complete visibility of the runtime security vulnerabilities to the users where the users can view, understand, and take actions to fix the vulnerabilities based on the alert notification.

Further, the management node may determine a distributed software system (e.g., a business application) that is impacted by the vulnerability in the operating system component, application component, or both and generate an alert notification indicating that the distributed software system is vulnerable. Thus, examples described herein may provide an ability to auto detect and flag the vulnerability for business applications and pinpoint the infrastructure elements that are vulnerable.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

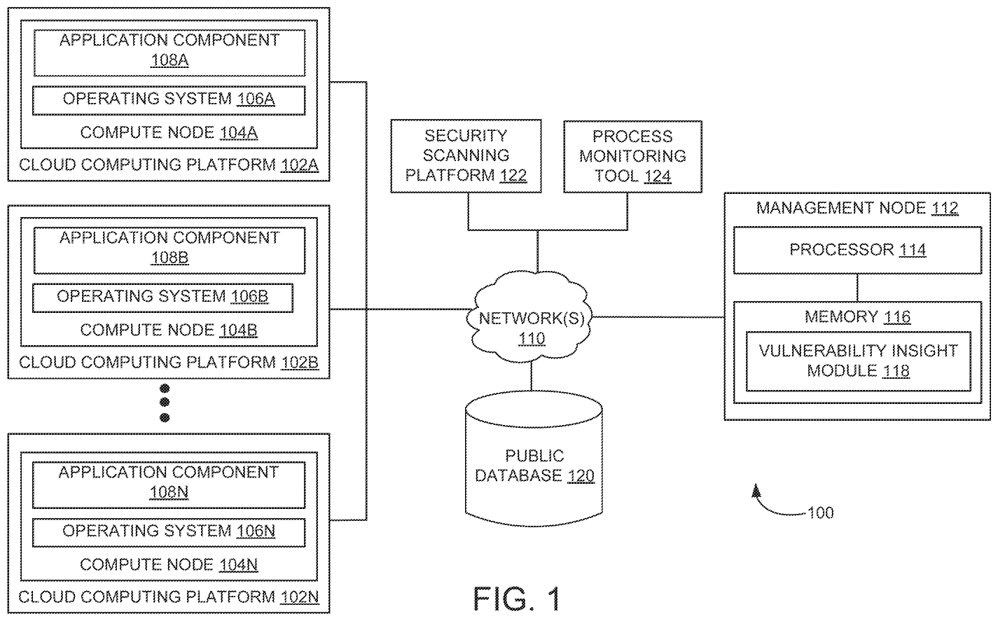

FIG. 1 is a block diagram of an example computing environment 100, depicting a management node 112 to detect and flag vulnerabilities for a distributed software system. The distributed software system may refer to a construct which involves various infrastructure parties that act together to enable a business service. An example distributed software system is an online book service including a database Tier and a web Tier. In this example, any vulnerability found on the database Tier, a web Tier, or both, may affect the online book service.

Example computing environment 100 may be a networked computing environment such as an enterprise computing environment, a cloud computing environment, a virtualized environment, a cross-cloud computing environment, or the like. An example cloud computing environment is VMware vSphere®. As shown in FIG. 1, example computing environment 100 may include multiple cloud computing platforms 102A-102N including corresponding compute nodes 104A-104N. Further, each of compute nodes 104A-104N includes corresponding local operating systems 106A-106N supporting corresponding application components 108A-108N to execute different applications.

Further, cloud computing platforms 102A-102N may be in communication with management node 112 over one or more networks 110. Communication may be according to a protocol, which may be a message-based protocol. For example, network 110 can be a managed Internet protocol (IP) network administered by a service provider. For example, network 110 may be implemented using wireless protocols and technologies, such as Wi-Fi, WiMAX, and the like. In other examples, network 110 can also be a packet-switched network such as a local area network, wide area network, metropolitan area network, Internet network, or other similar type of network environment. In yet other examples, network 110 may be a fixed wireless network, a wireless local area network (LAN), a wireless wide area network (WAN), a personal area network (PAN), a virtual private network (VPN), intranet or other suitable network system and includes equipment for receiving and transmitting signals. Network 110 can also have a hard-wired connection to compute nodes 104A-104N.

Example compute nodes 104A-104N may include, but not limited to, physical computing devices, virtual machines, containers, or the like. The virtual machines, in some embodiments, may operate with their own guest operating systems on a physical computing device using resources of the physical computing device virtualized by virtualization software (e.g., a hypervisor, a virtual machine monitor, and the like). A container is a data computer node that runs on top of a host operating system without the need for a hypervisor or separate operating system. Management node 112 may refer to a computing device or computer program (i.e., executing on a computing device) that provides service to compute nodes 104A-104N or application components 108A-108N executing on respective compute nodes 104A-104N.

Application components 108A-108N may run on different compute nodes 104A-104N or cloud computing platforms 102A-102N and communicate through network 110 to achieve a specific business function or task associated with a service. In the example shown in FIG. 1, the distributed software system is a collection of application components 108A-108N that provides the business function or task that can be used internally, externally, or with other business applications. The distributed software system may refer to a multi-tier application that divides an enterprise application into two or more application components that may be separately developed and executed. In an example, the tiers in a multi-tier application may include a presentation tier (e.g., provides basic user interface and application access services), an application processing tier (e.g., possesses the core business or application logic), a data access tier (e.g., provides the mechanism used to access and process data), and/or a data tier (e.g., holds and manages data that is at rest).

Examples described in FIG. 1 depict management node 112 in communication with compute nodes 104A-104N, however, in some examples, a group of management nodes or a cluster of management nodes can communicate with multiple compute nodes 104A-104N over one or more networks 110 to provide services to compute nodes 104A-104N. Further, numerous types of applications or distributed software systems may be supported in computing environment 100. For example, distributed software systems may include vRealize Operations (VROps) (i.e., VMware's cloud monitoring platform), Log Insight (i.e., VMware's log analysis and management platform), vRealize Network Insight (vRNI) (i.e., VMware's network monitoring tool), Wavefront (i.e., VMware's cloud monitoring and analytics tool), and the like.

As shown in FIG. 1, management node 112 may execute centralized management services that may be interconnected to manage the resources centrally in computing environment 100. Example centralized management service may be enabled by VMware vRealize Operations (vROps), which is VMware's cloud monitoring platform. In an example, management node 112 may be communicatively connected to compute nodes 104A-104N, a public database 120, a security scanning platform 122, and a process monitoring tool 124 via network 110.

Further, management node 112 includes a processor 114. Processor 114 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 114 may, for example, include single or multiple cores on a chip, multiple cores across multiple chips, multiple cores across multiple devices, or suitable combinations thereof. Processor 114 may be functional to fetch, decode, and execute instructions as described herein. Furthermore, management node 112 includes memory 116 coupled to processor 114. Example memory 116 includes a vulnerability insight module 118. In some examples, vulnerability insight module 118 may be provided as a plugin.

During operation, vulnerability insight module 118 may receive vulnerability data indicative of a vulnerability associated with computing environment 100 from security scanning platform 122. In an example, the vulnerability data may include data representing the vulnerability, such as a vulnerability signature. The vulnerability signature can refer to an attack pattern that is indicative of a threat or attack intended to exploit the vulnerability in the computer program. In another example, the vulnerability data may include data describing the vulnerability, such as data identifying any open ports on a given compute node. In this case, the open ports may provide access for possible intrusion, and potentially represent the vulnerability that can be exploited by a hacker.

The vulnerability data may originate from security scanning platform 122. Example security scanning platform 122 may be a vulnerability scanning tool such as Appcheck, (e.g., for detecting vulnerability in the code, operating system, third party software, and the like), Nessus (e.g., for scanning the information technology infrastructure, security audit, and the like), Carbon Black (e.g., for detecting vulnerabilities in the application), or the like.

Further, vulnerability insight module 118 may determine a type of the vulnerability. In an example, the type of the vulnerability may be determined by comparing the vulnerability with predefined vulnerabilities. For example, the type of vulnerability may be an open port vulnerability, a cross-site scripting (XSS) vulnerability, a cipher suite vulnerability, a code/library vulnerability, or any combination thereof.

In an example, the open port vulnerability refers to a security gap caused by an open port on compute nodes 104A-104N. Attackers can use the open ports to access the compute nodes and associated data. The XSS vulnerability may refer to a web security vulnerability that allows an attacker to compromise the interactions that users have with a vulnerable application. In this example, an attacker injects malicious executable scripts into the code of a trusted application or a website.

Further, cipher suites are sets of instructions that enable secure network connections through transport layer security (TLS), often still referred to as secure sockets layer (SSL). The cipher suites provide a set of algorithms and protocols required to secure communications between clients and servers. The cipher suite vulnerability refers to an insecure cipher that allows an attacker to establish an insecure SSL/TLS connection and launch different attacks. Furthermore, computer programs/software products (e.g., application components 108A-108N, underlying operating systems 106A-106N, or both) may be susceptible to security vulnerabilities. The code/library vulnerability is a flaw or weakness in an application/library and/or underlying operating system that could be exploited to compromise the security of the application.

Furthermore, vulnerability insight module 118 may determine an operating system component, an application component, or both being vulnerable to a security threat based on the type of vulnerability. In an example, vulnerability insight module 118 may fetch/obtain process details, port details, or both corresponding to the type of vulnerability form process monitoring tool 124. Process monitoring tool 124 may monitor resources like servers, hosts, and virtual machines in computing environment 100 to track metrics across the software products. The process monitoring tool 124 may locate the source of potential issues and current problems using the metrics including CPU, memory, storage, network, and disk usage to ensure optimal performance. Further, vulnerability insight module 118 may map the process details, port details, or both to the operating system component, the application component, or both. Furthermore, vulnerability insight module 118 may determine that the operating system component, the application component, or both being vulnerable to the security threat based on the mapping.

For example, in case of the open port vulnerability, cross-site scripting (XSS) vulnerability, and a cipher suite vulnerability, the vulnerabilities may be matched to the applications running on the reported ports (e.g., fetched via process monitoring tool 124). In case of the code/library vulnerability, the libraries may be compared by a process using utilities such as Isof, ProcessExplorer, or the like. In case of any new type of the vulnerability, vulnerability identification can be plugged in via a plugin architecture.

Further, vulnerability insight module 118 may determine a distributed software system that is impacted by the vulnerability in the operating system component, application component, or both. The distributed software system may be a multi-tier application including multiple application components 108A-108N distributed across multiple compute nodes 104A-104N in computing environment 100 for execution. Furthermore, vulnerability insight module 118 may generate an alert notification indicating that the distributed software system is vulnerable. In an example, vulnerability insight module 118 may determine a recommended action to mitigate a security vulnerability related to the security threat and generate the alert notification including the recommended action to mitigate the security vulnerability related to the security threat.

In another example, vulnerability insight module 118 may retrieve vulnerability information associated with the vulnerability from public database 120. Example public database 120 may be a common vulnerabilities and exposures (CVE) database, a vulnerability database maintained by MITRE, a National Vulnerability Database (NVD) maintained by National Institute of Standards and Technology (NIST), or the like, which includes a list of publicly disclosed computer security flaws (i.e., known attack patterns). In this example, vulnerability insight module 118 may retrieve the vulnerability information from websites driven by public database 120 through the representational state transfer (REST) application programming interfaces (APIs) exposed by these websites.

In some examples, public database 120 may be maintained by the Software Engineering Institute at Carnegie Mellon University of Pittsburgh, Pa., a CVE scheme maintained by MITRE Corporation of Bedford, Mass., the Bugtraq vulnerability list maintained by Security Focus of SYMANTEC CORPORATION of Mountain View, Calif. Various entities, corporations, or software firms may also maintain public vulnerabilities registries regarding the products they develop in relevant websites. In an example, vulnerability insight module 118 can be configured to receive, access, look up, process, analyze, or otherwise obtain and utilize information of one or more vulnerabilities lists or registries in one or more formats, standards, or schemes. For example, vulnerability insight module 118 can be configured to use the CVE vulnerability scheme created by MITRE Corporation.

Further, vulnerability insight module 118 may generate the alert notification including the vulnerability information and present the alert notification including the vulnerability information on a graphical user interface and/or invoke a corresponding application programming interface to send the alert notification including the vulnerability information to a management application.

In an example, vulnerability insight module 118 may generate the alert (e.g., critical, immediate, warning, or the like) based on a common vulnerability scoring system (CVSS) score. The CVSS is an open framework for communicating the characteristics and severity of software vulnerabilities. For example, the CVSS provides a numerical (e.g., 0-10) representation (i.e., the score) of the severity of the vulnerability. Further, when there are multiple vulnerabilities on the same compute node, a single alert may be generated (e.g., to keep check of the alert storm), however, the alert may include all the vulnerabilities listed.

In some examples, the functionalities described in FIG. 1, in relation to instructions to implement functions of vulnerability insight module 118 and any additional instructions described herein in relation to the storage medium, may be implemented as engines or modules including any combination of hardware and programming to implement the functionalities of the modules or engines described herein. The functions of vulnerability insight module 118 may also be implemented by a processor. In examples described herein, the processor may include, for example, one processor or multiple processors included in a single device or distributed across multiple devices.

In an example, examples described herein may be implemented in an analysis tool that provides operational visibility. The analysis tool described herein may be provided as a security insight feature, which facilitates users to view the security vulnerabilities present in the compute nodes in no time. Thus, the user may be able to figure out their products and applications which are currently vulnerable and which part of system is affected by the vulnerabilities. Further, examples described herein may also present a detailed explanation about the vulnerability to help the users to understand the vulnerability. Furthermore, the recommendation may suggest a set of actions users need to perform in other to get rid of these vulnerabilities and secure their applications.

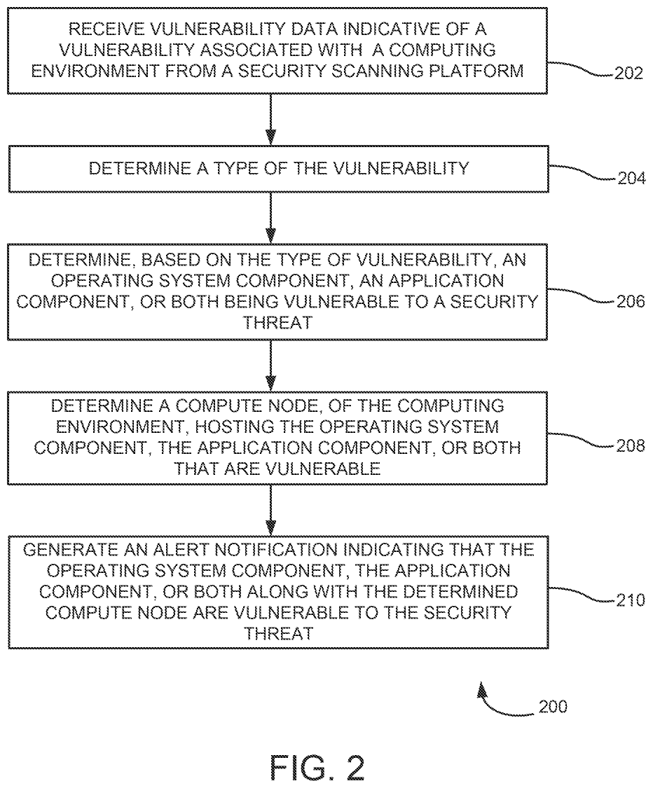

FIG. 2 is a flow diagram illustrating an example computer-implemented method 200 for generating an alert notification indicating a vulnerability in a computing environment. At 202, vulnerability data indicative of a vulnerability associated with a computing environment may be received from a security scanning platform. At 204, a type of the vulnerability may be determined. In an example, the type of the vulnerability may be determined by comparing the vulnerability with predefined vulnerabilities. For example, the type of vulnerability includes an open port vulnerability, a cross-site scripting (XSS) vulnerability, a cipher suite vulnerability, a code/library vulnerability, or any combination thereof.

At 206, an operating system component, an application component, or both being vulnerable to a security threat may be determined based on the type of vulnerability. In an example, process details, port details, or both corresponding to the type of vulnerability may be fetched. For example, fetching process details, port details, or both includes collecting metrics corresponding to operating system components, application components, or both via monitoring tool that monitors the computing environment, and fetching process details, port details, or both corresponding to the type of vulnerability from the collected metrics. Further, the process details, port details, or both may be mapped to the operating system component, the application component, or both. Based on the mapping, the operating system component, the application component, or both that are being vulnerable to the security threat may be determined.

At 208, a compute node, of the computing environment, hosting the operating system component, the application component, or both that are vulnerable may be determined. At 210, an alert notification indicating that the operating system component, the application component, or both along with the determined compute node are vulnerable to the security threat may be generated. In an example, generating the alert notification includes determining a recommended action to mitigate a security vulnerability related to the security threat and generating the alert notification including the recommended action to mitigate the security vulnerability related to the security threat.

Further, a distributed software system that is impacted by the vulnerability in the operating system component, application component, or both may be determined. Furthermore, an alert notification indicating that the distributed software system is vulnerable may be generated.

In an example, vulnerability information associated with the vulnerability may be retrieved from a public database. In this example, retrieving the vulnerability information includes transmitting a hypertext transfer protocol (HTTP) get command to a web server that includes the public database and receiving a response to the HTTP get command from the web server, the response including the vulnerability information associated with the vulnerability.

Further, the alert notification including the vulnerability information may be generated. Furthermore, the alert notification including the vulnerability information may be presented on a graphical user interface, a corresponding application programming interface may be invoked to send the alert notification including the vulnerability information to a management application, or both.

Further, an insight may be generated based on the vulnerability information. In an example, generating the insight includes at least one of:
categorizing security vulnerabilities related to the security threat based on a type, a severity level, or both associated with the security threat,
providing an application-level visibility, a host-level visibility, or both associated with the security threat,
recommending an action to be performed to mitigate a security vulnerability related to the security threat,
classifying a severity of the security threat based on a vulnerability score, and
exploring an access exploitation and an impact of the security threat.

Further, the insight may be presented to a user via the graphical user interface, API, or both. Thus, examples described herein may provide a method for dynamically mapping a vulnerability to a distributed software system and to associated infrastructure elements so that the user is aware of the impacted critical businesses and initiates appropriate actions. Further, the method dynamically closes the alert when an issue associated with the vulnerability is resolved.

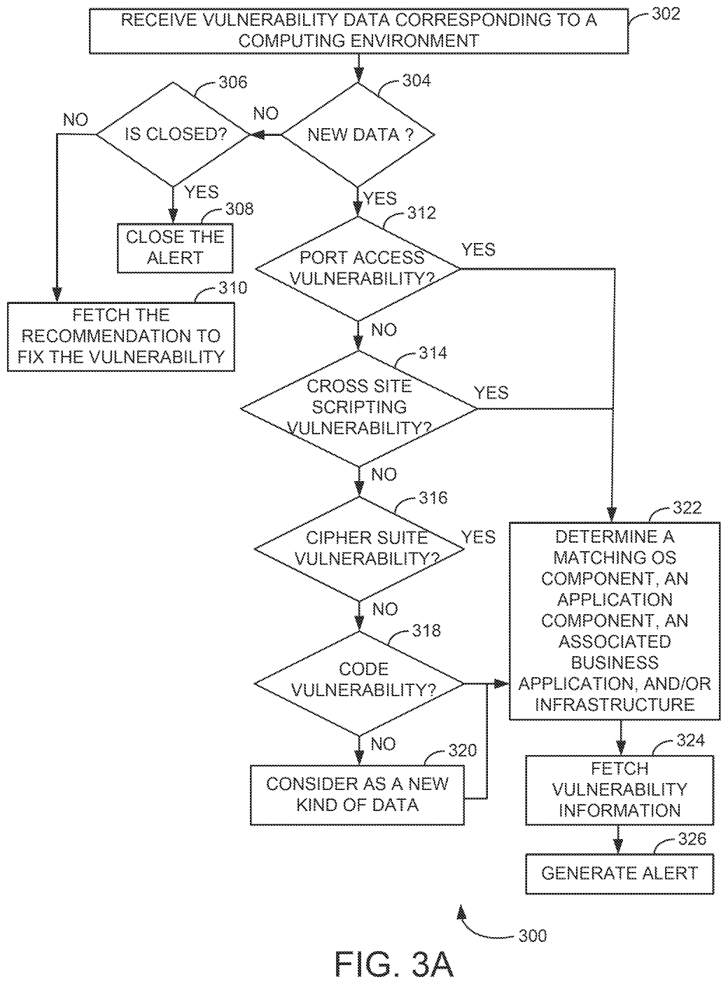

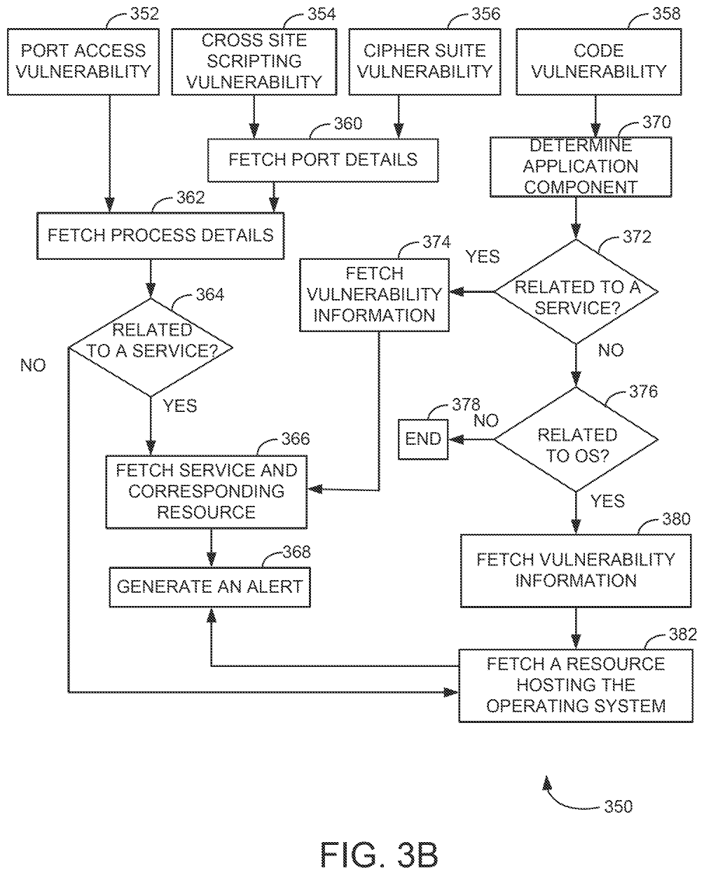

FIG. 3A is a flow diagram illustrating another example computer-implemented method 300 for generating an alert notification indicating a vulnerability in a business application (i.e., a distributed software system). At 302, vulnerability data corresponding to a computing environment may be received. The vulnerability data may include data representing the vulnerability or describing the vulnerability. At 304, a check may be made to determine whether the vulnerability data is new. When the vulnerability data is not new, a check may be made to determine whether an issue associated with the vulnerability data is closed, at 306. When the issue is resolved, an alert corresponding to the vulnerability may be closed, at 308. When the issue is yet to be resolved, a recommendation corresponding to the vulnerability may be retrieved from a local database to fix the issue, at 310.

When the vulnerability data is new, a type of the vulnerability may be determined. In an example, a check may be made to determine whether the vulnerability data is related to a port access vulnerability (e.g., at 312), a cross site scripting (XSS) vulnerability (e.g., at 314), a cipher suite vulnerability (e.g., at 316), or a code vulnerability (e.g., 318). Further, if the vulnerability data does not match with a predetermined type, the vulnerability may be considered as a new type of vulnerability, at 320.

Upon determining the type of the vulnerability, a matching physical infrastructure resource (e.g., a compute node), an application component, an operating system component, a business application, or a combination thereof affected by the vulnerability may be determined from process details (e.g., performance metrics) associated with the compute nodes, at 322. At 324, vulnerability information corresponding to the vulnerability may be fetched, for instance, from a public database. The vulnerability information includes a mitigation action to mitigate the vulnerability. At 326, an alert including the mitigation action may be generated based on the vulnerability information.

FIG. 3B is a flow diagram illustrating yet another example computer-implemented method 350 for generating an alert notification based on a vulnerability in a business application. In case of a cross-site scripting (XSS) vulnerability (e.g., at 354) and a cipher suite vulnerability (e.g., at 356), port details associated with the vulnerability may be fetched, at 360. Further, process details associated with the vulnerability may be fetched at 362. In case of an open port vulnerability (e.g., at 352), the process details associated with the vulnerability may be fetched at 362.

At 364, a check may be made to determine whether the vulnerability is related to a business service. When the vulnerability is related to the business service, corresponding service information (e.g., an application component) and an infrastructure resource (e.g., a compute node) associated with the service may be fetched, at 366. At 368, an alert may be generated based on the fetched information (i.e., information corresponding to the application and corresponding compute node). Also, the alert may include recommendation to resolve the vulnerability. When the vulnerability is not related to the business service, a resource (i.e., the compute node) hosting an operating system corresponding to the vulnerability may be fetched, at 382. Further, the alert may be generated based on the fetched information (i.e., information corresponding to the operation systema and compute node hosting the operating system), at 368.

In case of a code/library vulnerability (e.g., at 358), an application component affected by the vulnerability may be determined, at 370. At 372, a check may be made to determine whether the vulnerability is related to a business service. When the vulnerability is related to the business service, vulnerability information may be fetched, at 374, for instance from a public database. Further, at 366, corresponding service information (e.g., the application component) and the infrastructure resource (e.g., the compute node) associated with the business service may be fetched. At 368, an alert may be generated based on the fetched information (i.e., information corresponding to the application component and corresponding compute node). When the vulnerability is not related to the business service, a check may be made to determine whether the vulnerability is associated with an operating system, at 376. When the vulnerability is not associated with the operating system, method 350 may be terminated, at 378. When the vulnerability is associated with the operating system, the vulnerability information may be fetched, at 380. Further, the infrastructure resource (i.e., the compute node) hosting the operating system corresponding to the vulnerability may be fetched, at 382. Further, the alert may be generated based on the fetched information (i.e., information corresponding to the operating system and compute node hosting the operating system), at 368.

Example methods 200, 300, and 350 depicted in FIGS. 2, 3A, and 3B represent generalized illustrations, and other processes may be added, or existing processes may be removed, modified, or rearranged without departing from the scope and spirit of the present application. In addition, methods 200, 300, and 350 may represent instructions stored on a computer-readable storage medium that, when executed, may cause a processor to respond, to perform actions, to change states, and/or to make decisions. Alternatively, methods 200, 300, and 350 may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but the flow chart illustrates functional information to design/fabricate circuits, generate computer-readable instructions, or use a combination of hardware and computer-readable instructions to perform the illustrated processes.

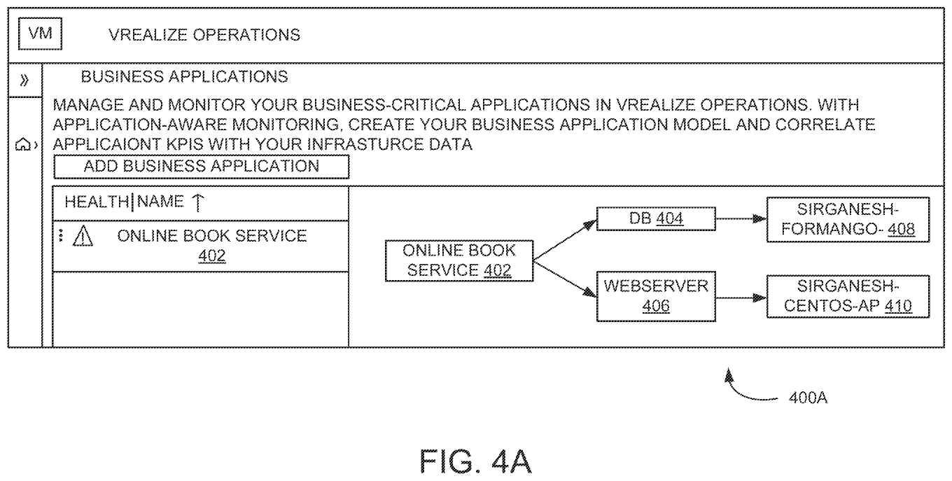

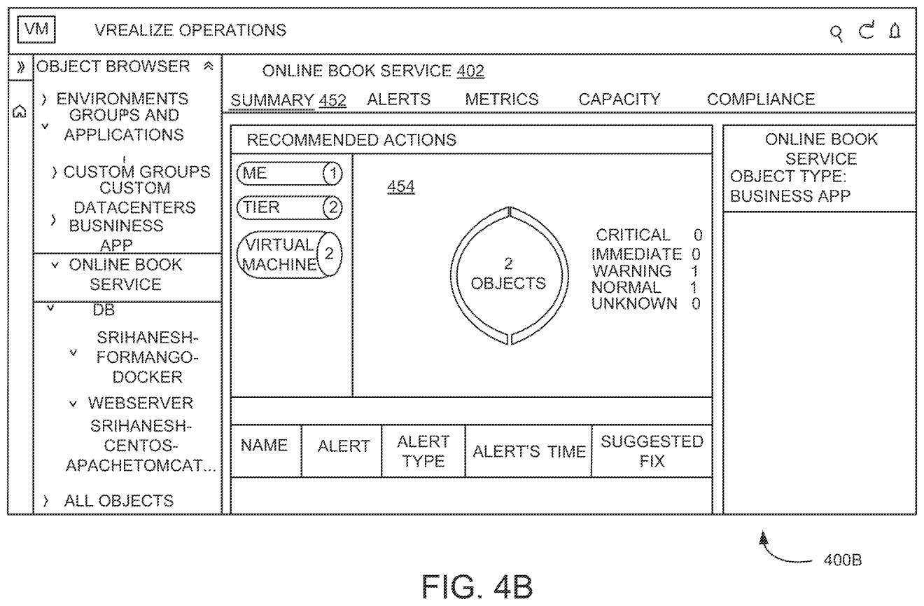

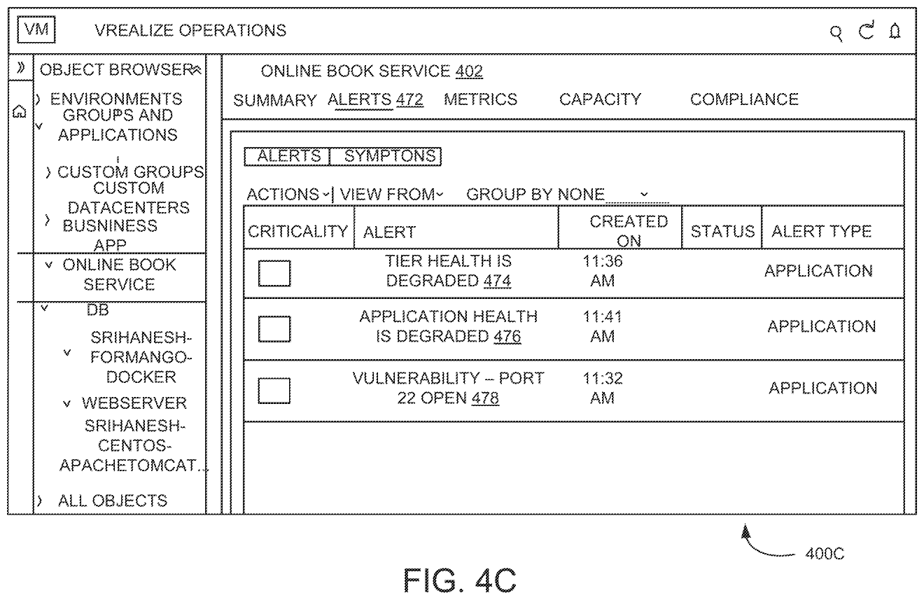

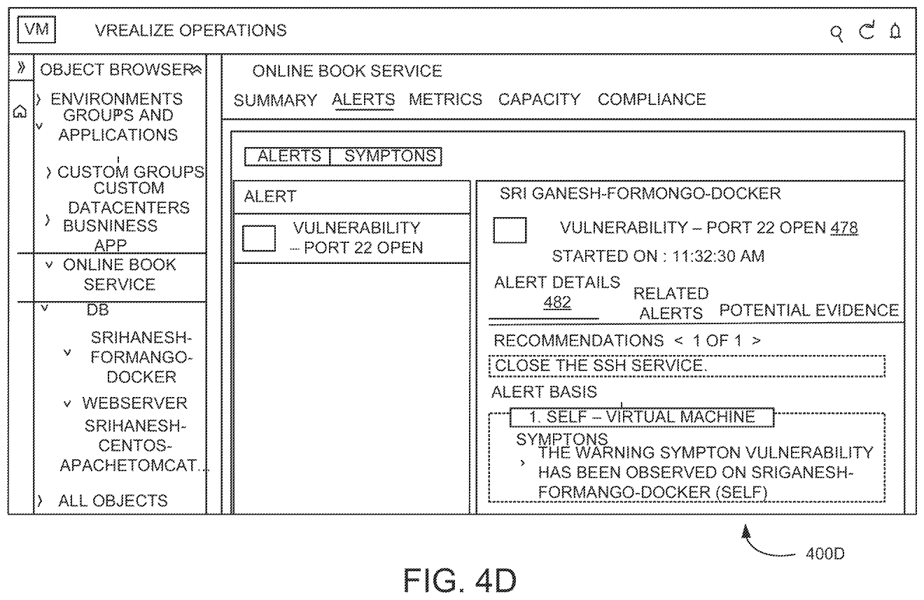

FIG. 4A is an example graphical user interface 400A depicting a distributed software system (e.g., an online book service 402) operating on multiple distributed compute nodes (e.g., a database server and a webserver) connected over the Internet. Example online book service 402 includes a database tier 404 and a Web tier 406. Database tier 404 may host Mongo database (DB) 408 and Web tier 406 hosts Tomcat 410.

In some examples, the distributed software system (e.g., a business application/service) can be made of software which is hosted on different distributed compute nodes (e.g., servers). The application could be impacted because of a vulnerability in two ways:
when an application component constituting the business application is vulnerable (e.g., Apache Tomcat 410, which is part of the application “online book service” 402 indicates a “Log 4j” code/library vulnerability), and
when an underlying operating system contributing to the business application has a vulnerability. For example, the Photon operating system hosting the Mongo database 408 which is part of “online book service” 402 application, has a vulnerability on Photon libraries.

In either case, the business service may be impacted. Examples described herein flags the business application/service and corresponding resource (i.e., the distributed infrastructure that hosts the business application/service) affected by the vulnerability and presents on a graphical user interface as depicted in FIGS. 4B to 4D.

FIG. 4B is an example graphical user interface 400B depicting a summary 452 of vulnerabilities in the distributed software system (e.g., online book service 402). Example graphical user interface 400B includes a display portion 454 to depict a number of objects affected by the vulnerability. For example, on the Mongo DB machine, consider that SSH port 22 is open. When the vulnerability insight detects this, an alert may be generated on the virtual machine (VM) hosting the Mongo DB. Thus, the defined business service “Online Book Service 402” also lights up as shown in FIG. 4B.

FIG. 4C is an example graphical user interface 400C depicting generated alerts 472 corresponding to individual application components of online book service 402. For example, example graphical user interface 400C depicts different alerts associated with the individual application components such as “tier health is degraded” 474, “application health is degraded” 476, and “port 22 open” 478 as shown in FIG. 4C.

FIG. 4D is an example graphical user interface 400D depicting generated alert details 482 corresponding to an alert 478 of FIG. 4C. Similarly, the individual elements (in this example, the Mongo DB VM), also show the alert, details, and recommendation to fix the “port 22 open” vulnerability. Thus, examples described herein may provide an approach to generate alert or flag the vulnerability from various computing sources, along with the support to remediate the vulnerability to manage vulnerability. Further, graphical user interfaces 400B, 400C, and 400D may provide an option to explore vulnerabilities, impact of the vulnerabilities along with potential fixes (i.e., potential solutions to mitigate the security vulnerabilities related to the attack), and the like. Thus, examples described herein provides the graphical user interfaces to depict visualisation of the detected vulnerabilities in a single pane of glass.

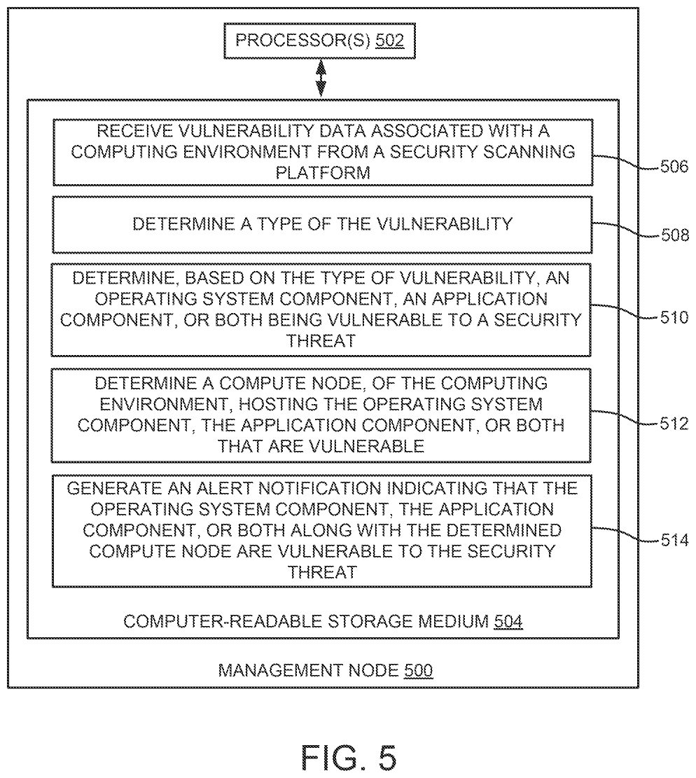

FIG. 5 is a block diagram of an example management node 500 including non-transitory computer-readable storage medium 504 storing instructions to detect vulnerabilities in a computing environment. Management node 500 may include a processor 502 and computer-readable storage medium 504 communicatively coupled through a system bus. Processor 502 may be any type of central processing unit (CPU), microprocessor, or processing logic that interprets and executes computer-readable instructions stored in computer-readable storage medium 504. Computer-readable storage medium 504 may be a random-access memory (RAM) or another type of dynamic storage device that may store information and computer-readable instructions that may be executed by processor 502. For example, computer-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 504 may be a non-transitory computer-readable medium. In an example, computer-readable storage medium 504 may be remote but accessible to management node 500.

Computer-readable storage medium 504 may store instructions 506, 508, 510, 512, and 514. Instructions 506 may be executed by processor 502 to receive vulnerability data indicative of a vulnerability associated with a computing environment from a security scanning platform. Instructions 508 may be executed by processor 502 to determine a type of the vulnerability. Instructions 510 may be executed by processor 502 to determine an operating system component, an application component, or both being vulnerable to a security threat based on the type of vulnerability.

Instructions 512 may be executed by processor 502 to determine a compute node, of the computing environment, hosting the operating system component, the application component, or both that are vulnerable.

Instructions 514 may be executed by processor 502 to generate an alert notification indicating that the operating system component, the application component, or both along with the determined compute node are vulnerable to the security threat. In an example, instructions 514 to generate the alert notification include instructions to determine a recommended action to mitigate a security vulnerability related to the security threat and generate the alert notification including the recommended action to mitigate the security vulnerability related to the security threat.

Further, computer-readable storage medium 504 may store instructions to determine a distributed software system that is impacted by the vulnerability in the operating system component, application component, or both. The distributed software system may be a multi-tier application including multiple application components distributed across multiple compute nodes in the computing environment for execution. Furthermore, computer-readable storage medium 604 may store instructions to generate an alert notification indicating that the distributed software system is vulnerable.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method comprising:
receiving vulnerability data indicative of a vulnerability associated with a computing environment from a security scanning platform;
determining a type of the vulnerability;
determining, based on the type of vulnerability, an operating system component, an application component, or both being vulnerable to a security threat;
determining a compute node, of the computing environment, hosting the operating system component, the application component, or both that are vulnerable; and
generating an alert notification indicating that the operating system component, the application component, or both along with the determined compute node are vulnerable to the security threat.

2. The method of claim 1, further comprising:
determining a distributed software system that is impacted by the vulnerability in the operating system component, application component, or both, wherein the distributed software system is a multi-tier application including multiple application components distributed across multiple compute nodes in the computing environment for execution; and
generating an alert notification indicating that the distributed software system is vulnerable.

3. The method of claim 1, wherein determining the operating system component, the application component, or both are vulnerable to the security threat comprises:
fetching process details, port details, or both corresponding to the type of vulnerability;
mapping the process details, port details, or both to the operating system component, the application component, or both; and
determining that the operating system component, the application component, or both being vulnerable to the security threat based on the mapping.

4. The method of claim 3, wherein fetching process details, port details, or both comprises:
collecting metrics corresponding to operating system components, application components, or both via monitoring tool that monitors the computing environment; and
fetching the process details, port details, or both corresponding to the type of vulnerability from the collected metrics.

5. The method of claim 1, wherein determining the type of the vulnerability comprises:
determining the type of the vulnerability by comparing the vulnerability with predefined vulnerabilities.

6. The method of claim 1, wherein the type of vulnerability comprises an open port vulnerability, a cross-site scripting (XSS) vulnerability, a cipher suite vulnerability, a code/library vulnerability, or any combination thereof.

7. The method of claim 1, wherein generating the alert notification comprises:
determining a recommended action to mitigate a security vulnerability related to the security threat; and
generating the alert notification including the recommended action to mitigate the security vulnerability related to the security threat.

8. The method of claim 1, further comprising:
retrieving vulnerability information associated with the vulnerability from a public database;
generating the alert notification including the vulnerability information; and
presenting the alert notification including the vulnerability information on a graphical user interface, invoking a corresponding application programming interface to send the alert notification including the vulnerability information to a management application, or both.

9. The method of claim 8, further comprising:
generating an insight based on the vulnerability information; and
presenting the insight to a user via the graphical user interface, application programming interface (API), or both.

10. The method of claim 9, wherein generating the insight comprises at least one of:
categorizing security vulnerabilities related to the security threat based on a type, a severity level, or both associated with the security threat;
providing an application-level visibility, a host-level visibility, or both associated with the security threat;
recommending an action to be performed to mitigate a security vulnerability related to the security threat;
classifying a severity of the security threat based on a vulnerability score; and
exploring an access exploitation and an impact of the security threat.

11. The method of claim 8, wherein retrieving the vulnerability information comprises:
transmitting a hypertext transfer protocol (HTTP) get command to a web server that includes the public database; and
receiving a response to the HTTP get command from the web server, the response including the vulnerability information associated with the vulnerability.

12. A management node comprising:
a processor; and
memory coupled to the processor, wherein the memory comprises:
a vulnerability insight module to:
receive vulnerability data indicative of a vulnerability associated with a cloud computing environment from a security scanning platform;
determine a type of the vulnerability;
determine, based on the type of vulnerability, an operating system component, an application component, or both being vulnerable to a security threat;
determine a distributed software system, deployed in the cloud computing environment, that is impacted by the vulnerability in the operating system component, application component, or both, wherein the distributed software system is a multi-tier application including multiple application components distributed across multiple compute nodes in the computing environment for execution; and
generate an alert notification indicating that the distributed software system is vulnerable.

13. The management node of claim 12, wherein the vulnerability insight module is to:
determine a compute node, of the computing environment, hosting the operating system component, the application component, or both that are vulnerable; and
generate an alert notification indicating that the operating system component, the application component, or both along with the determined compute node are vulnerable.

14. The management node of claim 12, wherein the vulnerability insight module is to:
fetch process details, port details, or both corresponding to the type of vulnerability;
map the process details, port details, or both to the operating system component, the application component, or both; and
determine that the operating system component, the application component, or both being vulnerable to the security threat based on the mapping.

15. The management node of claim 14, wherein the vulnerability insight module is to:
collect metrics corresponding to operating system components, application components, or both via monitoring tool that monitors the computing environment; and
fetch the process details, port details, or both corresponding to the type of vulnerability from the collected metrics.

16. The management node of claim 12, wherein the vulnerability insight module is to determine the type of the vulnerability by comparing the vulnerability with predefined vulnerabilities.

17. The management node of claim 12, wherein the vulnerability insight module is to:
determine a recommended action to mitigate a security vulnerability related to the security threat; and
generate the alert notification including the recommended action to mitigate the security vulnerability related to the security threat.

18. A non-transitory computer-readable storage medium encoded with instructions that, when executed by a processor of a management node, cause the processor to:
receive vulnerability data indicative of a vulnerability associated with a computing environment from a security scanning platform;
determine a type of the vulnerability;
determine, based on the type of vulnerability, an operating system component, an application component, or both being vulnerable to a security threat;
determine a compute node, of the computing environment, hosting the operating system component, the application component, or both that are vulnerable; and
generate an alert notification indicating that the operating system component, the application component, or both along with the determined compute node are vulnerable to the security threat.

19. The non-transitory computer-readable storage medium of claim 18, further comprising instructions to:
determine a distributed software system that is impacted by the vulnerability in the operating system component, application component, or both, wherein the distributed software system is a multi-tier application including multiple application components distributed across multiple compute nodes in the computing environment for execution; and
generate an alert notification indicating that the distributed software system is vulnerable.

20. The non-transitory computer-readable storage medium of claim 18, wherein the instructions to generate the alert notification comprise instructions to:
determine a recommended action to mitigate a security vulnerability related to the security threat; and
generate the alert notification including the recommended action to mitigate the security vulnerability related to the security threat.
